(19) United States
(12) Patent Application Publication
(10) Pub. No.: US 2024/0200683 A1
(43) Pub. Date: Jun. 20, 2024

(54) VALVE DEVICE

(71) Applicant: AISAN KOGYO KABUSHIKI KAISHA, Obu-shi, Aichi (JP)

(72) Inventor: Mitsuyoshsi ITAHARA, Obu-shi, Aichi (JP)

(21) Appl. No.: 18/286,419

(22) PCT Filed: Feb. 22, 2022
(86) PCT No.: PCT/JP2022/007381

§ 371 Date: Oct. 11, 2023

(30) Foreign Application Priority Data
Apr. 16, 2021 (JP) 2021-069954

(51) Int. Cl. F16K 31/44; F16K 1/12

(52) U.S. Cl. CPC F16K 31/44; F16K 1/12

(57) ABSTRACT

A valve device that includes a first valve body including an opening; a second valve body arranged within the first valve body and movable relative to the first valve body; a first valve seat arranged around an opening of a valve chamber, wherein the first valve body contacts the first valve seat; a second valve seat arranged around the opening of the first valve body, wherein the second valve body contacts the second valve seat; a piston applying a force to the second valve body by contacting the second valve body such that the second valve body is separated from the second valve seat; a movement restricting member fixed to the first valve body and restricting a movement of the second valve body in an axial direction relative to the first valve body; and a rotation restricting member restricting rotation of the first valve body relative to the second valve body.

### TECHNICAL FIELD

This application claims priority to Japanese Patent Application No. 2021-069954 filed on Apr. 16, 2021, the contents of which are hereby incorporated by reference into the present application. Technologies disclosed in the present description relate to valve devices.

### BACKGROUND ART

A valve device is described in Japanese Patent Application Publication No. 2019-121269 (hereinafter, referred to as Patent Document 1). In the valve device of Patent Document 1, a valve body biased by a spring closes an opening of a valve chamber. Further, the valve device of Patent Document 1 includes a piston that separates the valve body from the opening (a valve seat at the opening) in response to a pressure decrease in a downstream portion of a flow passage (positioned downstream of the valve device). That is, the piston applies a force to the valve body in response to a pressure decrease in the downstream portion of the flow passage, so that the opening is opened.

### SUMMARY OF INVENTION

In the valve device of Patent Document 1, the separation of the valve body from the valve seat allows a fluid to flow through a space between the valve body and the valve chamber, and the fluid is thus supplied to a portion downstream of the valve device. In the valve device of Patent Document 1, the supply of fluid can be increased by increasing a distance between the valve body and the valve seat, however, even so, a significant increase in the supply is not expected because the size of the space between the valve body and the valve chamber (size of the flow passage) remains the same. With a hollow valve body (first valve body) provided and another valve body (second valve body) disposed within the first valve body, the fluid is supplied in a normal amount (when large supply is not necessary) by opening only the second valve body, and the supply of fluid can be increased when necessary by additionally opening the first valve body.

Meanwhile, in the case of using the first valve body and the second valve body, the second valve body closes an opening of the first valve body and the first valve body closes the opening of the valve chamber by the second valve body being biased toward the opening of the valve chamber by a spring. In this case, while the valve device is open (supplying the fluid), rotation of the second valve body is restricted by the pressing force of the spring but the first valve body may rotate. Rotation of the first valve body may cause a change in the positional relationship between the first valve body and the opening (a valve seat at the opening) when the valve device is closed. The change in the positional relationship between the first valve body and the opening changes the scalability of the valve device. As a result, “leakage” may occur in the valve device. The present description aims to provide technologies for improving sealability of a valve device.

A first technology disclosed in the present description is a valve device comprising a first valve body, a second valve body, a valve chamber, a first valve seat, a second valve seat, a spring, a piston, a movement restricting member, and a rotation restricting member. The first valve body may be hollow and include an opening. The second valve body may be arranged within the first valve body, be movable relative to the first valve body, and include a projection projecting from the opening of the first valve body. The valve chamber may house the first valve body and include an opening. The first valve seat may be arranged around the opening of the valve chamber and the first valve body may contact the first valve seat. The second valve seat may be arranged around the opening of the first valve body and the second valve body may contact the second valve seat. The spring may bias the second valve body toward the second valve seat. The piston may apply a force to the second valve body by contacting the projection of the second valve body such that the second valve body is separated from the second valve seat. The movement restricting member may be fixed to the first valve body and restrict a movement of the second valve body in an axial direction relative to the first valve body. The rotation restricting member may restrict rotation of the first valve body relative to the second valve body.

A second technology disclosed in the present description is the valve device according to the above first technology, wherein a recess recessed in the axial direction of the second valve body may be defined in a portion of the second valve body close to the movement restricting member. Further, the movement restricting member may comprise a protrusion protruding toward the second valve body, and the protrusion may enter the recess when the second valve body contacts the movement restricting member. In this valve device, the rotation restricting member may be comprised of the recess and the protrusion.

A third technology disclosed in the present description is the valve device according to the above second technology, wherein the protrusion may be positioned outward of the spring which biases the second valve body.

A fourth technology disclosed in the present description is the valve device according to the above third technology, wherein the movement restricting member may be ring-shaped, and the two protrusions may be arranged at symmetrical positions with respect to a center of the movement restricting member.

A fifth technology disclosed in the present description is the valve device according to any one of the above first to fourth technologies, wherein a second spring that biases the first valve body toward the first valve seat may be disposed within the valve chamber, and the second spring may constitute the rotation restricting member.

### Advantageous Effects of Invention

According to the first technology, rotation of the first valve body can be suppressed while the valve device is in operation (supplying a fluid). Since the rotation of the first valve body is suppressed, displacement of a sealing position of the first valve body (position of the first valve body relative to the first valve seat) is suppressed when the first valve body sits on the first valve seat.

According to the second technology, rotational movement of the first valve body can be restricted by the recess and the protrusion contacting each other. It should be noted that in the valve device disclosed in the present description, the piston separates the second valve body from the second valve seat (around the opening of the first valve body) by applying a force thereto, and thereafter the first valve body is separated from the first valve seat (around the opening of the valve chamber) by the second valve body contacting the movement restricting member. That is, in the valve device comprising the first valve body and the second valve body, the movement restricting member is an essential member. The second technology allows for a reduction in the number of components by providing the second valve body with a function of a part of the rotation restricting member and providing the movement restricting member with a function of a part of the rotation restricting member.

According to the third technology, a flow passage for a fluid can be secured broad in a center portion of the movement restricting member (rotation restricting member). In other words, it is possible to suppress the movement restricting member from narrowing the flow passage in the valve device.

According to the fourth technology, an increase in the number of protrusions formed on the movement restricting member can be suppressed and rotation of the first valve body can be restricted more securely (the function of the rotation restricting member can be fully fulfilled).

According to the fifth technology, rotation of the first valve body itself can be restricted by the second spring, independent from the second valve body.

### BRIEF DESCRIPTION OF DRAWINGS

FIG. 1 shows a cross-sectional view of a valve device according to a first embodiment;

FIG. 2 shows an enlarged view of a portion enclosed by a broken line in FIG. 1;

FIG. 3 shows a state in which the valve device according to the first embodiment is in operation;

FIG. 4 shows a state in which the valve device according to the first embodiment is in operation;

FIG. 5 shows a perspective view of a part of a rotation restricting member;

FIG. 6 shows a perspective view of a part of the rotation restricting member;

FIG. 7 shows a cross-sectional view of a major portion of a valve device according to a second embodiment; and

FIG. 8 shows a cross-sectional view of a major portion of a valve device according to a third embodiment.

### DESCRIPTION OF EMBODIMENTS

### First Embodiment

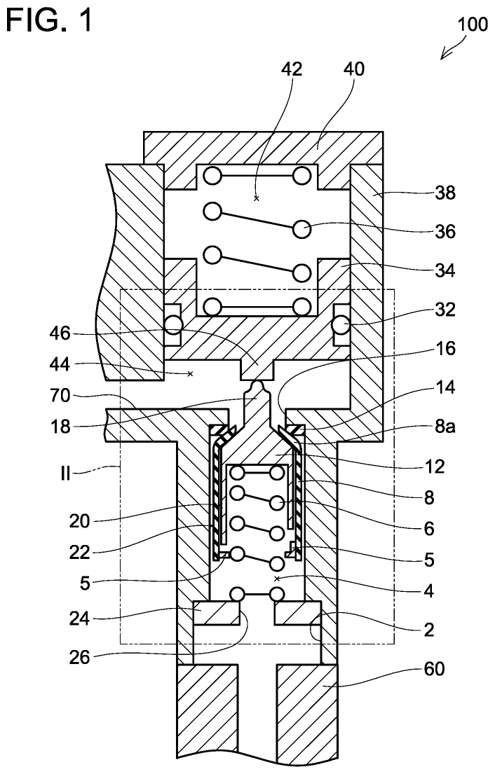

Referring to FIGS. 1 to 6, a valve device 100 is described. The valve device 100 is mounted, for example, in a vehicle comprising a fuel cell system and is disposed in a hydrogen gas pipe through which hydrogen is supplied to fuel cells. The valve device 100 operates to open the hydrogen gas pipe when hydrogen needs to be supplied to the fuel cells, while it stops its operation to close the hydrogen gas pipe when hydrogen does not need to be supplied to the fuel cells.

As shown in FIG. 1, the valve device 100 comprises a housing 38, a first valve body 8, a second valve body 12, and a piston 34. The valve bodies 8, 12 and the piston 34 are housed in the common housing 38. The first valve body 8 and the piston 34 section the inside of the housing 38 into a valve chamber 4, a piston chamber 42, and a hydrogen gas flow passage 44. The valve chamber 4 comprises a hydrogen gas inlet 2 and a hydrogen gas outlet 16. The hydrogen gas outlet 16 is an example of opening of the valve chamber 4. The hydrogen gas inlet 2 is connected to a hydrogen tank (not shown) via a pipe 60. A spacer 24 is fixed at the hydrogen gas inlet 2. The spacer 24 is ring-shaped, has its outer circumference contact (fixed to) the valve chamber 4, and has an opening 26 in its center.

The second valve body 12 is arranged within the first valve body 8. That is, the first valve body 8 is hollow. A first valve seat (seal material) 14 is disposed around the hydrogen gas outlet 16. The first valve body 8 contacts (sits on) the first valve seat 14. The first valve body 8 is disposed in the valve chamber 4. The first valve body 8 includes an opening, and a portion around the opening forms a second valve seat 8a. The second valve body 12 contacts (sits on) the second valve seat 8a. The hydrogen gas outlet 16 is closed by the first valve body 8 contacting the first valve seat 14 and the second valve body 12 contacting the second valve seat 8a. Further, a leading end portion 18 of the second valve body 12 is smaller in size than the opening of the first valve body 8 and projects into the hydrogen gas flow passage 44. The leading end portion 18 is an example of projection of the second valve body. The leading end portion 18 contacts a leading end portion 46 of the piston 34. The second valve body 12 is biased by a coil spring 6 toward the second valve seat 8a. The coil spring 6 contacts the second valve body 12 at its one end and contacts the spacer 24 at the other end. Further, the first valve body 8 is biased by the second valve body 12 (indirectly by the coil spring 6) toward the first valve seat 14.

The first valve body 8 and the second valve body 12 are not fixed to each other, and the first valve body 8 and the second valve body 12 are movable relative to each other. That is, the second valve body 12 can move in an axial direction relative to the first valve body 8. However, a ring member 5 that restricts the axial movement of the second valve body 12 relative to the first valve body 8 is fixed to the first valve body 8. The ring member 5 is an example of movement restricting member. The axial movement of the second valve body 12 relative to the first valve body 8 is restricted by the ring member 5. That is, while the second valve body 12 is in contact with the ring member 5, the first valve body 8 and the second valve body 12 move together in the axial direction. Protrusions are provided on portions of the ring member 5, and recesses are provided in portions of the second valve body. The protrusions and the recesses will be described later. It should be noted that a space 22 is defined between the first valve body and a wall surface of the valve chamber 4 (inner surface of the housing 38), and a space 20 is defined between the second valve body and an inner wall surface of the first valve body 8.

The piston chamber 42 is defined by the housing 38, a plate 40, and the piston 34. The plate 40 is fixed to the housing 38. The piston 34 is disposed in the housing 38. The piston 34 is not fixed to the housing 38 and is supported by the plate 40 via a coil spring 36. That is, the coil spring 36 is in contact with the plate 40 and the piston 34. A piston seal (O-ring) 32 is disposed between the piston 34 and the housing 38. The piston 34 separates the piston chamber 42 from the hydrogen gas flow passage 44. The piston chamber 42 is maintained at atmospheric pressure. The piston 34 moves in the housing 38 (slides relative to the housing 38) according to a pressure difference between the piston chamber 42 and the hydrogen gas flow passage 44. In the housing 38, the piston 34 is at a position where the compression force or tension force of the coil spring 36 balances the pressure difference between the piston chamber 42 and the hydrogen gas flow passage 44. Specifically, the piston 34 retracts (moves such that the space of the piston chamber 42 decreases) when the pressure in the hydrogen gas flow passage 44 increases, while the piston 34 advances (moves such that the space of the piston chamber 42 increases) when the pressure in the hydrogen gas flow passage 44 decreases.

### (Operation of Valve Device 100)

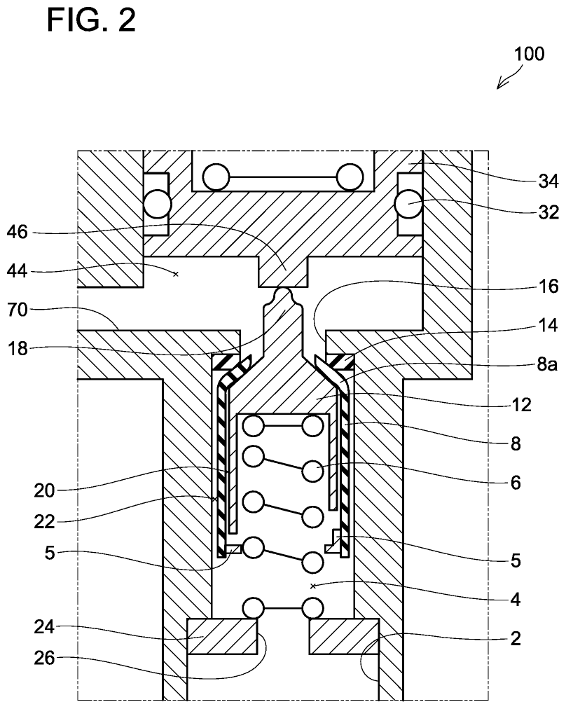

Referring to FIGS. 2 to 4, operation of the valve device 100 is described. When the pressure in the hydrogen gas flow passage 44 is relatively high, such as when hydrogen gas is not being supplied to the fuel cells, the piston 32 balances at a retraction position (FIG. 2). Thus, the first valve body 8 and the second valve body 12 closes the hydrogen gas outlet 16 by the biasing force of the coil spring 6. When the valve bodies 8, 12 closes the hydrogen gas outlet 16, hydrogen gas is not supplied to the hydrogen gas flow passage 44.

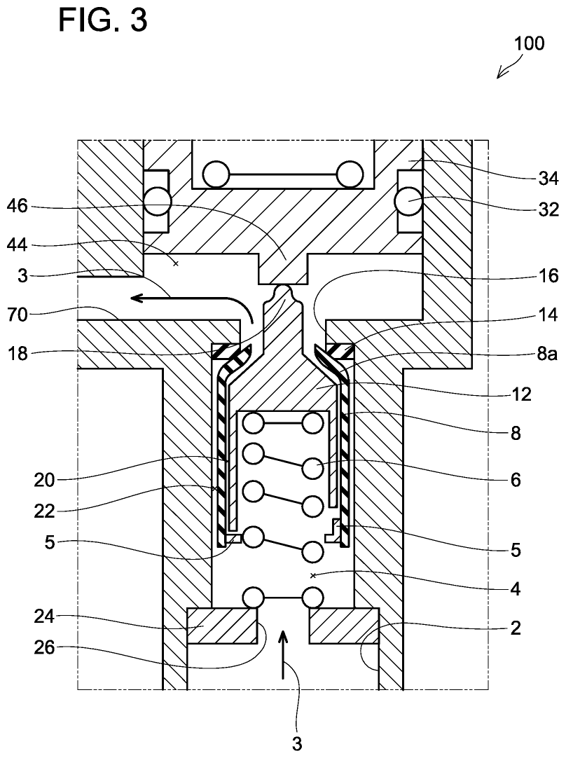

The pressure in the hydrogen gas flow passage 44 decreases in response to the start of hydrogen gas supply to the fuel cells. As the pressure in the hydrogen gas flow passage 44 decreases, the piston 34 advances according to the pressure difference between the piston chamber 42 and the hydrogen gas flow passage 44 (FIG. 3). Thus, the piston 34 applies a force to the second valve body 12, and the second valve body 12 is thereby separated from the second valve seat 8a. This allows the valve chamber 4 to communicate with the hydrogen gas flow passage 44 via the space between the first valve body 8 and the second valve body 12 (the valve device 100 operates). As a result, as indicated by arrows 3, the hydrogen gas flows from the pipe 60 into the hydrogen gas flow passage 44. After flowing through the hydrogen gas inlet 2, the hydrogen gas flows through the opening 26 of the spacer 24 and reaches the hydrogen gas outlet 16 via the space 20 between the first valve body 8 and the second valve body 12.

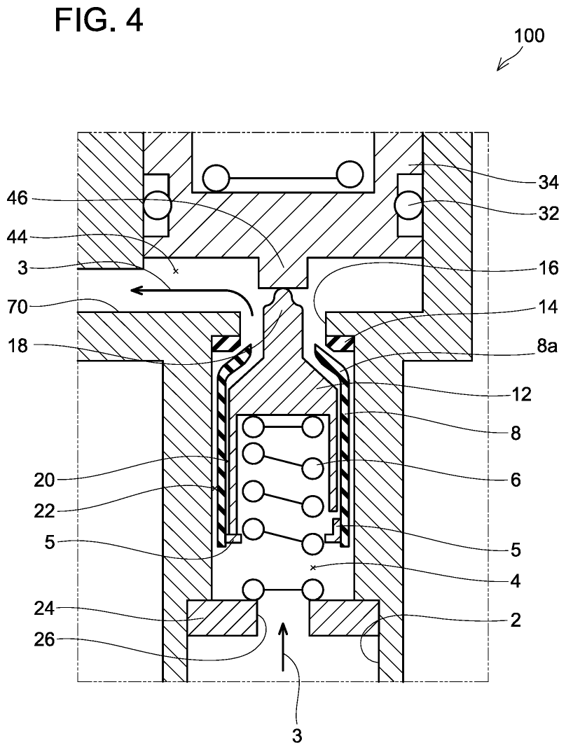

As the pressure in the hydrogen gas flow passage 44 further decreases, i.e., as the hydrogen gas supplied to the fuel cells is increased, the piston 34 advances further, so that the second valve body 12 is brought into contact with the ring member 5, and the first valve body 8 and the second valve body 12 together move in the axial direction (FIG. 4). As a result, the first valve body 8 is separated from the first valve seat 14, and a space is created between the first valve body 8 and the first valve seat 14. Consequently, the hydrogen gas can reach the hydrogen gas outlet 16 via the space 22 between the first valve body 8 and the wall surface of the valve chamber 4 as well as via the space 20 between the first valve body 8 and the second valve body 12. That is, the flow passage area in the valve device 100 is increased by the separation of the first valve body 8 from the first valve seat 14.

### (Rotation Restricting Member)

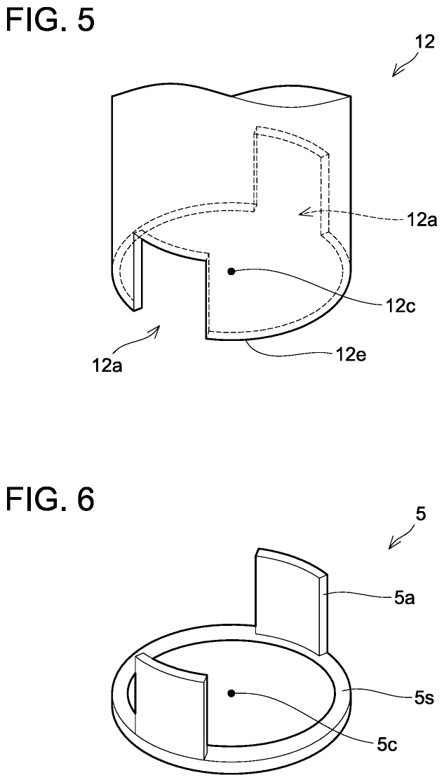

Referring to FIGS. 5 and 6, the second valve body 12 and the ring member 5 are described in detail. FIG. 5 shows a perspective view of an end portion of the second valve body 12 that is closer to the ring member 5, and FIG. 6 shows a perspective view of the ring member 5. As shown in FIG. 5, recesses 12a recessed from an end face 12e in the axial direction are defined in the second valve body 12. Two recesses 12a are arranged at symmetrical positions with respect to a center 12c of the second valve body 12. Further, as shown in FIG. 6, the ring member 5 comprises protrusions 5a protruding from a ring surface 5s. Two protrusions 5a are arranged at symmetrical positions with respect to a center 5c of the ring member 5.

The ring member 5 is fixed to an end portion of the first valve body 8 (end portion thereof closer to the spacer 24). More specifically, the ring member 5 is press-fitted to the inner surface of the first valve body 8 from the end portion of the first valve body 8 closer to the spacer 24. When the valve device 100 is not in operation, leading end portions of the protrusions 5a of the ring member 5 are in the recesses 12a (also see FIG. 2). Even when the valve device 100 starts to operate (FIG. 3) and the first valve body 8 starts to move together with the second valve body 12 (FIG. 4), the protrusions 5a are still in the recesses 12a. Thus, rotation of the first valve body 8 relative to the second valve body 12 is restricted. The protrusions 5a and the recesses 12a function as a rotation restricting member that restricts rotation of the first valve body 8 relative to the second valve body 12. It should be noted that rotation of the second valve body 12 is restricted by the biasing force of the coil spring 36. Thus, rotation of the first valve body 8 can be restricted while the valve device 100 is in operation by the first valve body 8 restricting the rotation of the first valve body 8 relative to the second valve body 12.

It should be noted that FIGS. 1 to 4 show cross sections of portions where a protrusion 5a and a recess 12a are arranged and portions where a protrusion 5a and a recess 12a are not arranged in order to clarify the relationship between the protrusion 5a and the recess 12a and the relationship between the second valve body 12 and the ring member 5 in the portions where a protrusion 5a and a recess 12a are not arranged. When the valve device 100 is not in operation (FIG. 2), the distance between the end face 12e of the second valve body 12 and the ring surface 5s of the ring member 5 is less than a protrusion height of the protrusions 5a from the ring surface 5s. Therefore, the protrusions 5a are in the recesses 12a even when the valve device 100 is not in operation. Since the protrusions 5a are constantly in the recesses 12a, rotation of the first valve body 8 can be restricted regardless of the state of the valve device 100 (out of operation or in operation).

The protrusion height of the protrusions 5a from the ring surface 5s is less than the depth of the recesses 12a (distance from the end face 12e of the second valve body 12 to the bottoms of the recesses 12a). Therefore, even when the protrusions 5a enter deep into the recesses 12a in response to the operation of the valve device 100, the leading ends of the protrusions 5a do not contact the bottoms of the recesses 12a. That is, even when the second valve body 12 contacts the ring member 5 (ring surface 5s), the leading ends of the protrusions 5a do not contact the bottoms of the recesses 12a (see FIG. 4). Thus, even with the protrusions 5a and the recesses 12a formed in/on the second valve body 12 and the ring member 5, the function of the ring member 5 as the movement restricting member is not impaired.

### (Advantages of Valve Device 100)

As described above, the valve device 100 comprises the rotation restricting member (the protrusions 5a and the recesses 12a) that restricts rotation of the first valve body 8. By restricting rotation of the first valve body 8, positional displacement between the first valve body 8 and the first valve seat 14 can be suppressed and thus the sealability of the valve device 100 (sealability between the first valve body 8 and the first valve seat 14) can be improved. As a result, “leakage” in the valve device 100 can be suppressed. Further, since the recesses 12a are formed in the second valve body 12 and the protrusions 5a are formed on the ring member 5 (movement restricting member), rotation of the first valve body 8 can be restricted without addition of a new component.

The protrusions 5a are positioned outward of the coil spring 6. This secures a large opening of the ring member 5 and thus secures a large flow passage for hydrogen gas. Further, since the protrusions 5a are arranged at symmetrical positions with respect to the center 5c and the recesses 12a are arranged at symmetrical positions with respect to the center 12c, rotation of the first valve body 8 can be restricted surely without increasing the number of the protrusions 5a and the recesses 12a. It should be noted that since the increase in the number of the protrusions 5a and the recesses 12a is suppressed, a turbulent flow of hydrogen gas can be suppressed.

### Second Embodiment

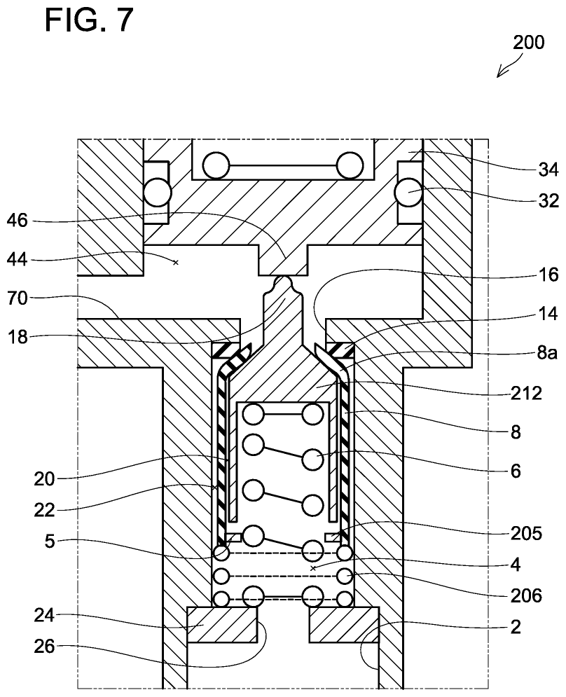

Referring to FIG. 7, a valve device 200 is described. The valve device 200 is a variant of the valve device 100, and configurations substantially same as those of the valve device 100 are labeled with the same reference signs as those used for the valve device 100 and description for them may be omitted. It should be noted that FIG. 7 shows a part of the valve device 200 that corresponds to the part of the valve device 100 shown in FIG. 2.

In the valve device 200, a ring member 205 that does not include any protrusions on its surface is fixed to the first valve body 8. The ring member 205 is an example of movement restricting member. Further, no recesses are defined in a second valve body 212. In the valve device 200, a coil spring 206 is disposed between the first valve body 8 and the spacer 24. The first valve body 8 is biased by the coil spring 206 toward the first valve seat 14. The coil spring 206 is an example of second spring. In the valve device 200, rotation of the first valve body 8 is restricted by the biasing force of the coil spring 206. That is, the valve device 200 can restrict rotation of the first valve body 9 independent from the second valve body 212. It should be noted that the valve device 200 has an advantage that rotation of the first valve body 8 can be restricted without machining the first valve body 8 and the second valve body 212 to form protrusions and recesses.

### Third Embodiment

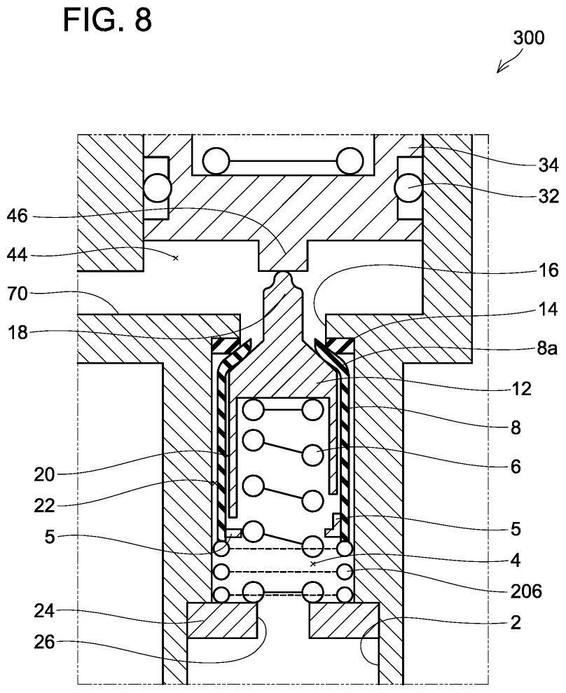

Referring to FIG. 8, a valve device 300 is described. The valve device 300 is a variant of the valve device 100, 200, and configurations substantially same as those of the valve device 100, 200 are labeled with the same reference signs as those used for the valve device 100, 200 and description for them may be omitted. It should be noted that FIG. 8 shows a part of the valve device 300 that corresponds to the part of the valve device 100 shown in FIG. 2.

The valve device 300 comprises features of both the valve device 100 and the valve device 200. Specifically, the valve device 300 comprises a rotation restricting structure with the protrusions 5a and the recesses 12a (rotation restriction member) and a rotation restricting structure with the coil spring 206 (rotation restricting member). The valve device can restrict rotation of the first valve body 8 more surely.

### OTHER EMBODIMENTS

In the valve devices of the first and third embodiments, the recesses are defined in the second valve body and the protrusions are formed on the movement restricting member (ring member). However, the protrusions may be formed on the second valve body and the recesses may be defined in the movement restricting member (ring member). Further, the number and positions of the recesses and protrusions can be varied as appropriate. For example, the number of the recesses and the protrusions may be one, or three or more. Further, the recesses and the protrusions may not be arranged at regular intervals in circumferential directions of the second valve body and the ring member. That is, even with two recesses and two protrusions, these recesses and protrusions may not be arranged at symmetrical positions with respect to the centers of the second valve body and the ring member.

The point of the valve devices disclosed in the present description is that the rotation restricting member that restricts rotation of the first valve body is provided in the valve chamber in which the first valve body and the second valve body are disposed. Thus, both in the case where the protrusions (a part of the rotation restricting member) are formed on the movement restricting member and in the case where the rotation restricting member is comprised of the second valve body and the ring member, for example, an elongated hole extending in the axial direction may be defined in the circumferential surface of the second valve body and an insertion portion that is to be inserted to the elongated hole may be formed on the ring member.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A valve device comprising:
a first valve body being hollow and including an opening;
a second valve body arranged within the first valve body and being movable relative to the first valve body, wherein the second valve body includes a projection projecting from the opening of the first valve body;
a valve chamber housing the first valve body and including an opening;
a first valve seat arranged around the opening of the valve chamber, wherein the first valve body contacts the first valve seat;
a second valve seat arranged around the opening of the first valve body, wherein the second valve body contacts the second valve seat;
a spring biasing the second valve body toward the second valve seat;
a piston applying a force to the second valve body by contacting the projection of the second valve body such that the second valve body is separated from the second valve seat;
a movement restricting member fixed to the first valve body and restricting a movement of the second valve body in an axial direction relative to the first valve body; and
a rotation restricting member restricting rotation of the first valve body relative to the second valve body.

2. The valve device according to claim 1, wherein
a recess recessed in the axial direction of the second valve body is defined in a portion of the second valve body close to the movement restricting member; and
the movement restricting member comprises a protrusion protruding toward the second valve body, and the protrusion enters the recess when the second valve body contacts the movement restricting member, and
the rotation restricting member is comprised of the recess and the protrusion.

3. The valve device according to claim 2, wherein the protrusion is positioned outward of the spring which biases the second valve body.

4. The valve device according to claim 3, wherein
the movement restricting member is ring-shaped, and
the two protrusions are arranged at symmetrical positions with respect to a center of the movement restricting member.

5. The valve device according to claim 4, wherein
a second spring that biases the first valve body toward the first valve seat is disposed within the valve chamber, and
the second spring constitutes the rotation restricting member.

6. The valve device according to claim 1, wherein
a second spring that biases the first valve body toward the first valve seat is disposed within the valve chamber, and
the second spring constitutes the rotation restricting member.
